(19) United States
(12) Patent Application Publication
(10) Pub. No.: US 2014/0131165 A1
(43) Pub. Date: May 15, 2014

(54) MATERIAL SAMPLING DEVICE WITH INTEGRATED MATERIAL ANALYZER ASSEMBLY

(71) Applicant: Johnson Industries, Inc., Pikeville, KY (US)

(72) Inventors: George F. Johnson, JR., Pikeville, KY (US); Arnemann R. Grender, Pippa Passes, KY (US)

(73) Assignee: Johnson Industries, Inc., Pikeville, KY (US)

(21) Appl. No.: 14/077,564

(22) Filed: Nov. 12, 2013

Related U.S. Application Data
(60) Provisional application No. 61/726,078, filed on Nov. 14, 2012.

(51) Int. Cl. B65G 49/00

(52) U.S. Cl. CPC B65G 49/00
USPC 198/339.1

(57) ABSTRACT

A material sampling and analyzing assembly comprises a material sampling device and a material analyzer assembly. The material sampling device is configured to extract a core sample of material from a supply of material. The material analyzer assembly is attached to a portion of the material sampling device. The material analyzer assembly comprises a first material analyzer configured to analyze a first testing sample, which comprises a first portion of the core sample. An alternate material sampling an analyzing assembly comprises a material sampling device comprising a discharge chute and a material analyzer assembly comprising a sample container and a material analyzer. The sample container is attached to the discharge chute. The sample container is configured to receive and temporarily retain a testing sample that is discharged from the discharge chute. The material analyzer is configured to analyze the testing sample while it is retained by the sample container.

### PRIORITY

This application claims priority to U.S. Provisional Patent Application Ser. No. 61/726,078, filed Nov. 14, 2012, entitled “Material Sampling Device with Integrated Material Analyzer,” the disclosure of which is incorporated by reference herein.

### BACKGROUND

Material samples have been obtained and analyzed in a variety of ways using a variety of devices. In particular, many different types of sampling devices have been used previously to obtain core samples of coal and other types of solid and granular materials. One such exemplary material sampling device is disclosed in U.S. Pat. No. 5,413,004, entitled “Method and Apparatus for Sampling Coal,” issued May 9, 1995 to Johnson et al., the disclosure of which is incorporated by reference herein. Existing sampling devices have not incorporated a material analyzer assembly into the sampling device itself. Instead, the material analyzer was separate from the sampling device and, in some cases, was positioned in a remote location. As a result, at least a portion of the core sample obtained by those devices (i.e. the testing sample) had to be transported away from the sampling device for analysis, which delayed the process.

While a variety of separate material sampling devices and material analyzing devices have been made and used, it is believed that no one prior to the inventors has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a side, cross-sectional view of an exemplary material sampling and analyzing assembly;

FIG. 2 depicts a side, cross-sectional view of the material sampling and analyzing assembly of FIG. 1 with a funnel and hose assembly positioned below the material analyzer assembly;

FIG. 3 depicts a side view of an alternate exemplary material analyzer assembly that includes two sample containers and a material analyzer;

FIG. 4 depicts a side view of an alternate exemplary material analyzer assembly that includes two sample containers and two material analyzers;

FIG. 5 depicts a side view of an alternate exemplary material analyzer assembly that includes a material analyzer assembly positioned below a discharge chute without a sample container;

FIG. 6 depicts a side view of an alternate exemplary material analyzer assembly that includes a conveyor and a material analyzer;

FIG. 7 depicts a side view of an alternate exemplary material analyzer assembly that includes a rotating sample container and a material analyzer;

FIG. 8 depicts a side view of an alternate exemplary material analyzer assembly that includes a vertically oriented rotating sample container assembly;

FIG. 9 depicts a side view of an alternate exemplary material analyzer assembly that includes a sample tray configured to travel back and forth through the material analyzer;

FIG. 10 depicts a side view of an exemplary rotating lid that can be used as a top or bottom door on a sample container; and

FIG. 11 depicts a perspective view of a prior art material analyzer.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Embodiments of the material sampling and analysis assemblies described herein may be used to obtain and analyze testing samples of any suitable solid or granular material, including but not limited to coal, potash, iron ore, grain, gravel and other types of solid and granular materials having a consistency substantially similar to gravel or coal. A testing sample comprises at least a portion of a core sample extracted from a supply of material by the material sampling device. The supply of material may be housed in any suitable container (e.g. a truck bed, a train car, shipping container, barge, etc.), arranged in a free-standing mound or pile, located within the ground or a rock formation, or in any other suitable location. For example, during operation, the material sampling and analyzing assembly may be lowered into a container of coal, such as a typical loaded coal truck, to extract core samples from the coal contained therein. It will be understood that, as used herein, the term “coal” represents coal and its impurities, which may include a large quantity of rock material in a “coal” sample.

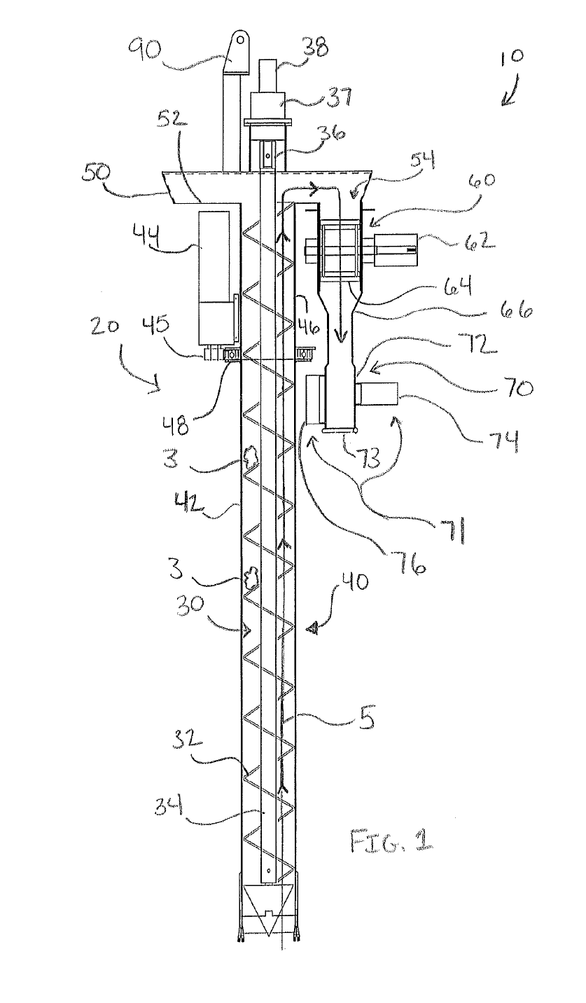

Embodiments of the present invention include material sampling devices that include a material analyzer assembly integrated into the sampling device at a discharge location thereby allowing an operator to both collect and analyze a testing sample without having to transport the testing sample to a separate device or area for analysis. FIG. 1 illustrates an exemplary material sampling and analyzing assembly 10. The material sampling and analyzing assembly 10 shown in FIG. 1 includes a material sampling device 20 that is configured to obtain a core sample of material from a supply of material. A core sample comprises the material extracted from the supply of material by the material sampling device. A core sample may comprise a random sample of material extracted across several different layers or strata of the supply of material. Specifically material sampling device 20 is a material sampling device with a rotatable tube assembly, such as the material sampling device disclosed in U.S. Pat. No. 8,171,808, entitled “Material Sampling Device With Rotatable Tube Assembly,” issued May 8, 2012 to Johnson et al., the disclosure of which is incorporated by reference herein. As shown in FIG. 1, the material sampling device 20 includes a vertical blade auger 30 within an outer tube 40. In the illustrated embodiment, the lower portion 42 of the outer tube 40 is configured to be rotated by the tube motor 44, while the upper portion 46 of the outer tube 40 is configured to remain stationary. Of course, as described in the '808 patent, the stationary portion 46 of the outer tube 40 may be eliminated in some embodiments.

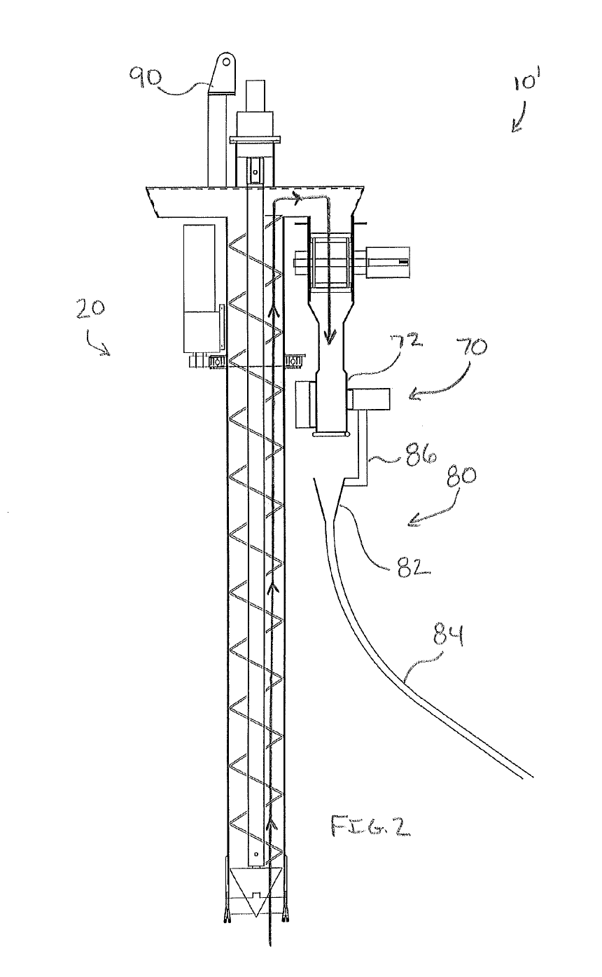

It will be appreciated that embodiments of the present invention may include other types of material sampling devices configured to obtain a core sample of material from a supply of material instead of the material sampling device 20 with a rotatable tube assembly as shown in FIG. 1 and described in the '808 patent. For example, in some embodiments, the material sampling device may be configured so that the entire outer tube remains stationary, instead of having a rotatable lower portion. In some of these embodiments, the outer tube may comprise a single piece without the tube motor 44 and turntable bearing 48 of the embodiment shown in FIGS. 1 and 2. In such an embodiment, the head at the bottom of the auger may rotate with the auger blades/flighting while the outer tube remains stationary and the ring with teeth and corresponding flange may be omitted. By way of example only, some embodiments may include a sampling device such as the one disclosed in U.S. Pat. No. 5,413,004, entitled “Method and Apparatus for Sampling Coal,” issued May 9, 1995 to Johnson et al., which was incorporated by reference above.

As shown in FIG. 1, the auger blade 32 ends at the top edge of the upper portion 46 of the outer tube 40, and the auger shaft 34 continues further up in the vertical direction to an auger drive coupling 36. In this embodiment, the auger shaft 34 is propelled by an auger motor 38. As shown, the output of auger motor 38 is connected to a gearbox 37, and the output of the gearbox 37 is then connected to the auger drive coupling 36, which is connected to the auger shaft 34. In an alternate embodiment, the gearbox 37 may be omitted entirely, allowing the auger motor 38 to drive the auger shaft 34 directly.

In the illustrated embodiment, the lower portion 42 of the outer tube 40 is driven by the tube motor 44. Specifically, the tube motor 44 is in mechanical communication with a driving gear 45, such that the tube motor 45 is configured to rotate the driving gear 45. As shown, the driving gear 45 is in mechanical communication with a turntable bearing 48, which is itself in mechanical communication with the lower portion 42 of the outer tube 40. Accordingly, the tube motor 44 is configured to cause the driving gear45, the turntable bearing 48, and, ultimately, the lower portion 42 of the outer tube 40 to rotate.

In the embodiment shown in FIG. 1, the material sampling device 20 includes a separator assembly 50 positioned adjacent to the top edge of the upper portion 46 of the outer tube 40. The separator assembly 50 includes a substantially horizontal shelf 52 that is adjacent to the top edge of the upper portion 46 of the outer tube 40. The open upper end of the outer tube 40 and the horizontal shelf 52 may provide an outlet for the extracted material moving up the outer tube 40. The horizontal shelf 52 may include one or more windows 54. Pieces of material 3 may be conveyed up the outer tube 40 via the auger 30, urged through the open upper end of the outer tube 40, onto the horizontal shelf 52, and, subsequently passed through a window 54. The flow of material through the sampling device 20 and into the temporary sample container 72 is generally indicated by arrow 5. The separator assembly may include a rotating arm (not shown) attached to the auger shaft 34 that is configured rotate in unison with the auger shaft 34 and push pieces of material 3 through the one or more windows in the horizontal shelf.

As shown in FIG. 1, one of the windows 54 in the horizontal shelf 52 opens into a crusher 60 that is powered by a crusher motor 62. If the horizontal shelf 52 includes additional windows, material that passes through those windows may be delivered back into the container or pile that is being sampled, to the ground, or to other pieces of equipment for further processing depending on the particular application. The crusher 60 may be configured to continuously crush pieces of material 3 that enter the crusher 60 into smaller pieces until they are small enough to fit through holes in the bottom floor 64 of the crusher 60. Of course, any suitable crusher 60 may be used. By way of example only, the crusher 60 may comprise a crusher such as the one disclosed in U.S. Pat. No. 7,360,725, entitled “Material Crusher,” issued Apr. 22, 2008 to Johnson et al, the disclosure of which is incorporated by reference herein. Of course, this particular crusher is not required. In alternate embodiments, the crusher may be omitted entirely, particularly if the material being sampled already comprises particles small enough to be analyzed. In these embodiments where the crusher is omitted entirely, the material may be delivered directly from the separator assembly 50 to the material analyzer assembly 70.

In the illustrated embodiment, the crusher 60 includes a crusher discharge chute 66 that receives the crushed material and directs it toward the material analyzer assembly 70. As shown, the material analyzer assembly 70 comprises a material analyzer 71 and a temporary sample container 72. In this embodiment, material analyzer 71 comprises a particle/energy source 74 and a detector 76 positioned on opposite sides of the temporary sample container 72. The material analyzer 71 may be configured to determine any suitable characteristic of the testing sample, including but not limited to the amount of rock or ash in the testing sample, the amount of sulfur in the testing sample, the amount of moisture in the testing sample, and the amount of certain trace elements in the testing sample. The material analyzer 71 may also be in communication with an evaluation unit or display that is configured to allow an operator to monitor the results of the analysis performed by the material analyzer 71. For example, the evaluation unit may comprise an evaluation unit such as the LB 444 evaluation unit sold by Berthold Technologies GmbH & Co. KG. The evaluation unit may be positioned in an operator's cab or any other location suitable to allow an operator to monitor the results of the analysis.

The material analyzer 71 may be configured to remain on continuously, or, alternatively, the material analyzer 71 may be configured to selectively switch between being on and off. For example, in some embodiments, the material analyzer 71 may be selectively switched on and off manually by an operator, while in other embodiments the material analyzer 71 may be switched on and off automatically after a certain time period, based on the presence or absence of sufficient material in the sample container, or based on the presence or absence of some other appropriate condition. Suitable sensors and/or timers may be incorporated within the material analyzer assembly 70 to provide this type of functionality, but they are not required. In some embodiments, the material analyzer assembly 70 may be configured to provide an immediate audio or visual indication regarding the analyzed properties. For example, the material analyzer assembly 70 may include an indicator light that is in communication with the material analyzer 71. The indicator light may be mounted on the sample container 72 or another portion of material sampling device 20 adjacent to the material analyzer assembly 70, mounted on the material analyzer 71, located on an evaluation unit that is in communication with the material analyzer 71, located on an operator control panel in communication with the material analyzer 71, or positioned in any other location suitable to provide notification to an operator. In such an embodiment, if the testing sample satisfies a predetermined condition, then the indicator light may indicate a satisfactory testing sample with a green light and if the testing sample does not satisfy a predetermined condition, then the indicator light may indicate an unsatisfactory testing sample with a red light.

In this embodiment, the temporary sample container 72 is attached to the end of the crusher discharge chute 66 in order to temporarily hold at least a portion of the crushed material discharged from the crusher 60 (i.e. the testing sample) while it is analyzed, before releasing the testing sample. The sample container 72 may be fixedly or removably attached to the crusher discharge chute 66. The sample container 72 may comprise any type of container suitably configured to receive and at least temporarily hold the testing sample for analysis. The sample container 72 may include a means configured to stir or mix the material in the sample container 72 in order to ensure uniformity of the testing sample, although this is not required. In alternate embodiments, the sample container 72 may be fixedly or removably attached to another portion of the sampling device 20, provided the sample container 72 is positioned to receive an amount of material that is sufficient to allow for the desired analysis. Similarly, although the particle/energy source 74 and the detector 76 are shown as being attached to the container 72, it will be appreciated that they may be fixedly or removably attached to another portion of the sampling device 20, such as crusher discharge chute 66, and positioned in any suitable arrangement, provided they are adequately positioned to analyze the testing sample contained in the sample container 72. It will be appreciated that in some embodiments, the crusher discharge chute 66 may be omitted and the material analyzer assembly 70 may be fixedly or removably attached to another portion of the sampling device 20 so that the sample container 72 is located at a discharge location suitable to obtain a testing sample. As shown, the source 74 and the detector 76 are oriented at an angle of about 90 degrees relative to the longitudinal axis of the sample container 72. It will be appreciated that in some embodiments, the source 74 and the detector 76 may be oriented an angle relative to the longitudinal axis of the sample container of about 30 degrees, 45 degrees, or any other angle suitable to allow the analyzer 71 to obtain the desired information about the testing sample.

In some embodiments, the sample container 72 may be removably attached to the crusher discharge chute 66 or any other suitable portion of the sampling device 20 such that the sample container can be removed once the testing sample has been collected and analyzed. Upon removal of the sample container, the testing sample can be returned to the material supply, used for further testing or analysis, retained for future use, discarded, or otherwise handled as desired. In such an embodiment, the removable sample container may or may not include a door or opening, such as door 73 described below.

The sample container 72 may be configured to receive all of the material that is crushed by the crusher, or, alternatively the sample container 72 may be configured to only receive a portion of the material crushed by the crusher 60. For example, the sample container may be configured to travel back and forth below the crusher discharge chute, such that the sample container is only intermittently in a position to receive crushed material. In such an embodiment, the source and detector may be fixedly or removably attached to the sample container or the source and detector may be fixedly or removably attached to the crusher discharge chute or another portion of the sampling device and the sample container may be configured to remain stationary between the source and detector for an amount of time sufficient to allow the desired analysis to be completed.

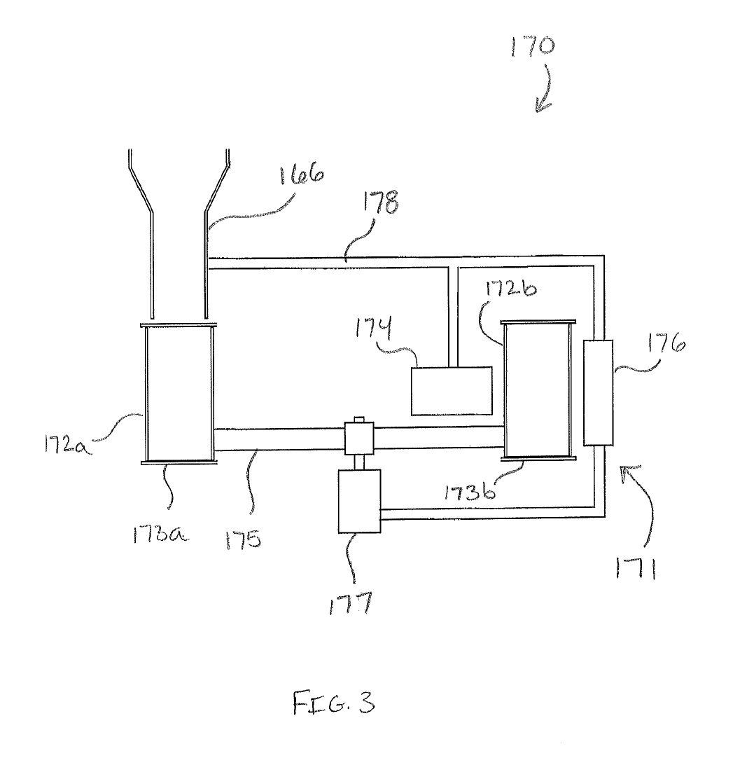

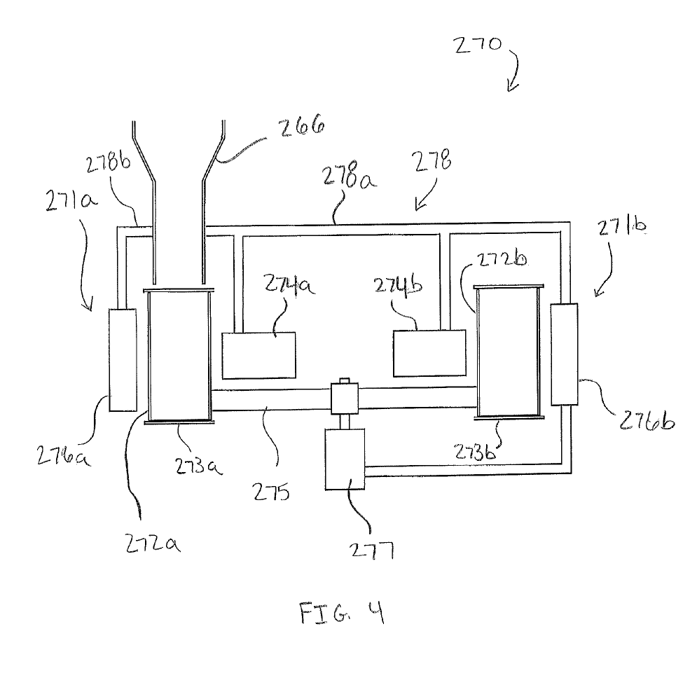

Although the illustrated embodiments shown in FIGS. 1 and 2 depict a material analyzer assembly 70 that includes single temporary sample container 72 and a single material analyzer 71, it will be appreciated that in other embodiments the material analyzer assembly may include any suitable number of temporary sample containers and material analyzers. By way of example only, in one such embodiment, the material analyzer assembly may include a plurality of temporary sample containers and a single material analyzer, such as the embodiment shown in FIG. 3 and described below. In such an embodiment, the temporary sample containers may be configured to rotate or travel to a suitable position to receive a testing sample from the crusher discharge chute and subsequently be analyzed one-by-one by the material analyzer. For example, the device may include a rotating table or arm that includes a plurality of temporary sample containers with a single material analyzer positioned to analyze material in each sample container as the table or arm rotates. In another alternate embodiment, such as the embodiment shown in FIG. 4 and described below, the material analyzer assembly may include a plurality of temporary sampling containers and a corresponding number of material analyzers such that each temporary sampling container/material analyzer pair rotates or travels to a suitable position to receive a testing sample from the crusher discharge chute. For example, in such an embodiment, the material analyzer assembly may include a rotating table or arm that includes a plurality of temporary sample containers that each have a respective material analyzer attached thereto.

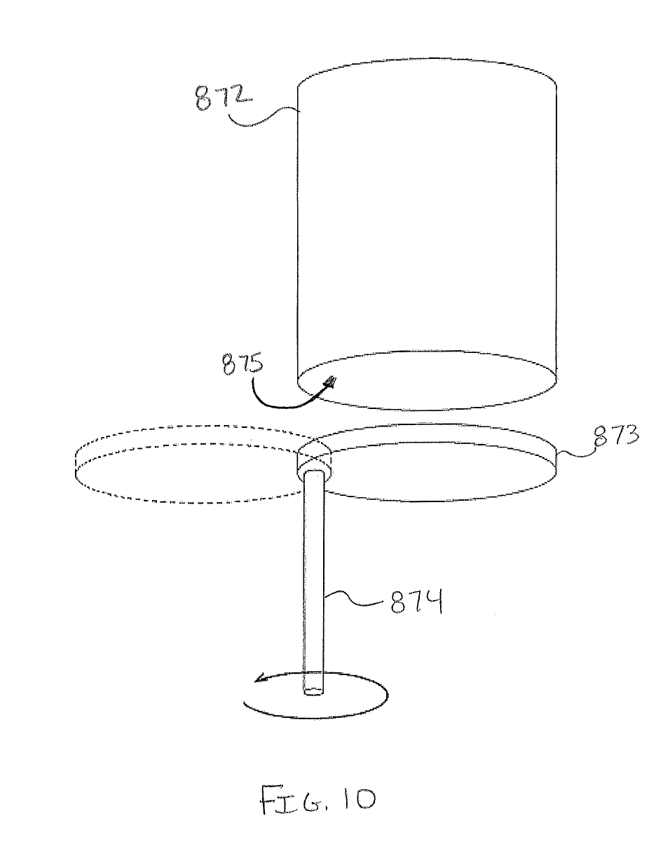

As shown in FIG. 1, the sample container 72 includes a door 73 at the bottom of the sample container 72 configured to selectively retain the testing sample within the sample container 72. The door 73 of the sample container 72 may be a hinged door, a sliding door, a butterfly door similar to a carburetor, a rotating lid (shown in FIG. 10 and described below), or any other suitable structure configured to selectively retain the testing sample within the sample container 72. The door/opening may also be positioned along the side of the container in some embodiments. In still other embodiments, the sample container may include two or more doors configured to selectively retain the testing sample within the sample container. The door 73 may be configured to be opened and closed manually by an operator or the door 73 may be configured to automatically open and close after a certain time period, based on the presence or absence of sufficient material in the sample container 72, or based on the presence or absence of some other appropriate condition. Suitable sensors and/or timers may be incorporated within the material analyzer assembly 70 to provide this type of functionality, but they are not required. As shown in FIG. 1, when the door 73 is opened, the testing sample may be released back into the container or pile from which it was obtained, released to the ground, or delivered to a transport means (chute, conveyor belt, etc.) (not shown).

In an exemplary method of operation, the door 73 of the sample container 72 is closed while the material sampling device 20 obtains material from the desired material source (e.g. a container (a truck bed, a train car, shipping container, barge, etc.), arranged in a free-standing mound or pile, located within the ground or a rock formation, etc.). The material is processed by the material sampling device 20 and falls down through the crusher discharge chute 66 into the sample container 72. The door 73 remains closed until an adequate amount of material is collected (i.e. the testing sample). The testing sample is then analyzed by the material analyzer 71. Once the analysis has been completed, then the door 73 is opened and the testing sample is released. When analysis of another testing sample is desired, the door 73 may be closed and the process can be repeated.

FIG. 2 depicts an alternate material sampling and analyzing assembly 10′ that includes a funnel and hose assembly 80 configured to catch the testing sample after it exits the material analyzer assembly 70. In this embodiment, a funnel 82 or other receptacle is positioned below the sample container 72 and is connected to a hose 84 that is configured to transport the testing sample to a desired container or location. For example, the hose 84 may be connected to a bag or some other container located in the operator's cab. It may be desirable to retain the testing sample for further analysis or additional processing. As shown, the funnel and hose assembly 80 is attached to the material sampling device 20 via a support arm 86 that extends from the source 74 to the funnel 82. It will be appreciated that the funnel and hose assembly 80 may comprise a free-standing structure separate from the material sampling device 20 or the funnel and hose assembly 80 may be fixedly or removably attached to the source 74 (as shown in FIG. 2), the detector 76, the sample container 72, the crusher discharge chute 66 or any other suitable portion of the sampling device 20.

In one embodiment the hose 84 may utilize gravity to transfer the testing sample from the funnel 82 to the desired location/container without the use of a vacuum. In an alternate embodiment, a vacuum source may be used to propel the particles from the funnel 82 into and through the hose 84. In another alternate embodiment, the hose 84 may be configured to use air pressure to transfer the particles from the funnel 82 through the hose 84 to the desired location/container. In these embodiments, the testing sample can be transported from the funnel 82 to the desired location/container without the use of any type of conveyor mechanism. However, it will be understood that in other embodiments, the testing sample could be delivered to a conveyor, chute or some other conveying means after being released from the sample container instead of being delivered into a hose 84.

The exemplary method of operation for the material analyzer assembly 70 shown in FIG. 2 is substantially the same as the method of operation for the embodiment shown in FIG. 1 described above. However, in the embodiment shown in FIG. 2, once the testing sample is released from the sample container 72, the testing sample is collected by the funnel and hose assembly 80 and delivered to a desired location/container.

As shown in FIGS. 1 and 2, the sampling device 20 includes an assembly support 90 at the top of the device 20. The assembly support 90 may be configured to allow the material sampling and analyzing assembly 10, 10′ to be suspended from and supported by a boom assembly, overhead crane, or other movable support structure. By way of example only, the assembly support 90 may be connected to a boom assembly operated by a lift mechanism, such as a hydraulic lift. In such an embodiment, the material sampling and analyzing assembly 10, 10′ may be movable both vertically and horizontally so that the material sampling and analyzing assembly 10, 10′ can be positioned above a pile of material or a container filled with material (e.g. a coal truck) and then lowered into the material to obtain a core sample/testing sample. In other embodiments, the material sampling and analyzing assembly 10, 10′ may be attached to a permanent or fixed structure, such as a building or tower, rather than being installed onto a portable apparatus, such as a trailer with a boom assembly or an overhead crane.

FIG. 3 depicts an alternate material analyzer assembly 170 configured to be fixedly or removably attached to a material sampling device. For example, material analyzer assembly 170 may be attached to a material sampling device such as material sampling device 20 described above and shown in FIGS. 1 and 2 or any other suitable material sampling device. As shown, material analyzer assembly 170 comprises a first temporary sample container 172a, a second temporary sample container 172b, a material analyzer 171, a rotating member 175, and a motor 177. Similar to material analyzer 71 described above, material analyzer 171 may be configured to remain on continuously, or, alternatively, the material analyzer 171 may be configured to selectively switch between being on and off. In addition, the material analyzer 171 may be configured to provide an immediate audio or visual indication regarding the analyzed properties. The additional description regarding the functionality material analyzer 71 above applies equally to the material analyzer 171 in FIG. 3. As a result, that description will not be repeated here.

The material analyzer 171 in FIG. 3 includes an energy/particle source 174 and a detector 176. The first sample container 172a and second sample container 172b are attached to opposite ends of the rotating member 175, and the rotating member 175 is in mechanical communication with a motor 177 that is configured to cause the rotating member 175, the first sample container 172a, and the second sample container 172b to rotate. The material analyzer assembly 170 is supported by a support structure 178 that is attached at one end to a discharge chute 166 of the material sampling device. If material analyzer assembly 170 is attached to a material sampling device that incorporates a crusher, such as material sampling device 20, then the discharge chute 166 may comprise a crusher discharge chute, such as the crusher discharge chute 66 described above. Alternatively, if material analyzer assembly 170 is attached to a material sampling device that does not incorporate a crusher, then the discharge chute 166 may be in direct communication with the separator assembly or another suitable portion of the material sampling device that delivers material for a testing sample into the discharge chute 166. Similar to the embodiments discussed above, material analyzer assembly 170 and/or support structure 178, may be removably or fixedly attached to any suitable portion of the material sampling device. It will be appreciated that in some embodiments, the discharge chute 166 may be omitted and the material analyzer assembly 170 and/or the support structure 178 may be fixedly or removably attached to another portion of the sampling device so that the first position is located at a discharge location suitable to obtain a testing sample.

In some embodiments, one or both of the sample containers 172a, 172b may be removably attached to the rotating member 175 such that one or both of the sample containers can be removed once the testing sample has been collected and analyzed. Upon removal of the sample container(s), the testing sample can be returned to the material supply, used for further testing or analysis, retained for future use, discarded, or otherwise handled as desired. In such an embodiment, the removable sample container(s) may or may not include a door or opening, such as doors 173a, 173b described below.

The first and second sample containers 172a, 172b are each configured to temporarily hold at least a portion of the crushed material discharged from the discharge chute 166 (i.e. the testing sample) while it is analyzed, before releasing the testing sample. Each sample container 172a, 172b includes a door 173a, 173b at the bottom of the respective sample container 172a, 172b configured to selectively retain the testing sample within the respective sample container 172a, 172b. The door 173a, 173b of the sample containers 172a, 172b may be a hinged door, a sliding door, a butterfly door similar to a carburetor, a rotating lid (shown in FIG. 10 and described below), or any other suitable structure configured to selectively retain the testing sample within the respective sample container 172a, 172b. The door/opening may also be positioned along the side of the respective container in some embodiments. In still other embodiments, one or both of the sample containers may include two or more doors configured to selectively retain the testing sample within the respective sample container. The door 173a, 173b may be configured to be opened and closed manually by an operator or the door 173a, 173b may be configured to automatically open and close after a certain time period, based on the presence or absence of sufficient material in the respective sample container 172a, 172b, or based on the presence or absence of some other appropriate condition. Suitable sensors and/or timers may be incorporated within the material analyzer assembly 170 to provide this type of functionality, but they are not required. When the respective door 173a, 173b is opened, the testing sample may be released back into the container or pile from which it was obtained, released to the ground, or delivered to a transport means (chute, conveyor belt, etc.) (not shown).

Material analyzer assembly 170 may be configured to rotate the first sample container 172a and the second sample container 172b between a first position and a second position. As shown, when the sample container 172a, 172b is in the first position, the sample container 172a, 172b is positioned underneath the discharge chute 166 to receive the testing sample. When the sample container 172a, 172b is in the second position, the sample container 172a, 172b is in a position to allow the testing sample to be analyzed by the material analyzer 171. Specifically, in the second position, the sample container 172a, 172b is positioned between the source 174 and the detector 176. As shown, the source 174 and the detector 176 are oriented at an angle of about 90 degrees relative to the longitudinal axis of the sample container 172a, 172b when the container 172a, 172b is in the second position. It will be appreciated that in some embodiments, the source 174 and the detector 176 may be oriented an angle relative to the longitudinal axis of the sample container in the second position of about 30 degrees, 45 degrees, or any other angle suitable to allow the analyzer 171 to obtain the desired information about the testing sample.

In an exemplary method of operation of the material analyzer assembly 170 shown in FIG. 3, the material sampling device obtains material from the desired supply of material (e.g. a container (a truck bed, a train car, shipping container, barge, etc.), arranged in a free-standing mound or pile, located within the ground or a rock formation, etc.). The material is processed by the material sampling device and falls down through the discharge chute 166. The first sample container 172a is positioned in the first position underneath the discharge chute 166 with door 173a closed for a period of time sufficient to allow the desired testing sample to be collected within the first sample container 172a. While the first sample container 172a is receiving the desired testing sample, if the second sample container 172b contains a testing sample of material, then the testing sample of material in the second sample container 172b may be analyzed by material analyzer 171. Once the desired testing sample has been collected within the first sample container 172a and, if applicable, once the analysis on the testing sample contained in the second sample container 172b has been completed, then the rotating member 175 rotates about 180 degrees. As a result of the rotation, the sample containers 171a, 171b switch positions. In other words, after the rotation, the second sample container 172b is positioned in the first position underneath the discharge chute 166 to receive a testing sample, and the first sample container 172a, which contains a testing sample, is positioned in the second position within the material analyzer 171 for analysis.

In this exemplary method of operation, while the testing sample in the first sample container 172a is being analyzed by the material analyzer 171, the second sample container 172b may release the previously analyzed testing sample (if applicable) by opening and closing the door 173b and then a new testing sample of material may be delivered into the second sample container 172b from the discharge chute 166. Subsequently, after the analysis of the testing sample in the first sample container 172a is completed and the new testing sample has been collected within the second sample container 172b, then the rotating member 175 again rotates about 180 degrees returning the first sample container 172a to the first position and the second sample container 172b to the second position. As described above, the previously analyzed testing sample in the first sample container 172a may be released by opening and closing door 173a and the process of filling one sample container 172a, 172b and analyzing the testing sample in the other sample container 172a, 172b is repeated. It will be appreciated that the previously analyzed testing sample may be released from the respective sample container 172a, 172b while the sample container 172a, 172b is in either the first or second position or during the rotation between the first and second positions.

Material analyzer assembly 170 may be configured to continuously rotate the sample containers 172a, 172b at a rate suitable to allow for adequate filling and analysis. Alternatively, the material analyzer assembly 170 may be configured to intermittently rotate the sample containers 172a, 172b at predetermined intervals suitable to allow for adequate filling and analysis or based on the presence or absence of a certain condition (e.g., when a certain amount of material has been collected within a respective sample container 172a, 172b, when analysis has been completed, etc.). Suitable sensors and/or timers may be incorporated within the material analyzer assembly 170 to provide this type of functionality, but they are not required. Although the material analyzer assembly 170 shown in FIG. 3 depicts two sample containers, it will be appreciated that other embodiments may incorporate any suitable number of sample containers.

In an alternate method of operation, material analyzer assembly 170 may be configured to continuously rotate the sample containers 172a, 172b such that the sample containers 172a, 172b intermittently pass underneath discharge chute 166 collecting material until such time as one or both of the sample containers 172a, 172b have collected a predetermined amount of material sufficient to constitute a desired testing sample. Once a desired testing sample has been collected in at least one of the sample containers 172a, 172b, then material analyzer assembly 170 may be configured to stop the sample container 172a, 172b containing the desired testing sample in the second position so that the testing sample in the respective sample container 172a, 172b can be analyzed by material analyzer 171. Once analysis of the desired testing sample has been completed, then the other sample container 172a, 172b may be rotated into the second position for analysis, if that sample container 172a, 172b also contains a sufficient testing sample.

FIG. 4 depicts another alternate material analyzer assembly 270 configured to be fixedly or removably attached to a material sampling device. For example, material analyzer assembly 270 may be attached to a material sampling device such as material sampling device 20 described above and shown in FIGS. 1 and 2 or any other suitable material sampling device. As shown, material analyzer assembly 270 comprises a first sample container 272a, a second temporary container 272b, a first material analyzer 271a, a second material analyzer 271b, a rotating member 275, and a motor 277. Similar to material analyzer 71 described above, material analyzers 271a, 271b may be configured to remain on continuously, or, alternatively, the material analyzers 271a, 271b may be configured to selectively switch between being on and off. In addition, the material analyzers 271a, 271b may be configured to provide an immediate audio or visual indication regarding the analyzed properties. The additional description regarding the functionality material analyzer 71 above applies equally to the material analyzers 271a, 271b in FIG. 4. As a result, that description will not be repeated here.

Material analyzers 271a, 271b in material analyzer assembly 270 may be the same type of analyzer or they may be different types of analyzers. In addition, material analyzers 271a, 271b in material analyzer assembly 270 may be configured to determine the same characteristic of the testing samples or they may be configured to analyze different characteristics of the testing samples. The first material analyzer 271a in FIG. 4 includes a first energy/particle source 274a and a first detector 276a. Similarly, the second material analyzer 272b in FIG. 4 includes a second energy/particle source 274b and a second detector 276b.

The first sample container 272a and second sample container 272b are attached to opposite ends of the rotating member 275, and the rotating member 275 is in mechanical communication with a motor 277 that is configured to cause the rotating member 275, the first sample container 272a, and the second sample container 272b to rotate. The material analyzer assembly 270 is supported by a support structure 278 that is attached to a discharge chute 266 of the material sampling device. As shown, the support structure 278 includes a first support arm 278a that supports the first source 274a, the second source 274b, the second detector 276b, the motor 277, the rotating member 275, and the sample containers 272a, 272b. The support structure 278 in FIG. 4 also includes a second support arm 278b that supports the first detector 276a. If material analyzer assembly 270 is attached to a material sampling device that incorporates a crusher, such as material sampling device 20, then the discharge chute 266 may comprise a crusher discharge chute, such as the crusher discharge chute 66 described above. Alternatively, if material analyzer assembly 270 is attached to a material sampling device that does not incorporate a crusher, then the discharge chute 266 may be in direct communication with the separator assembly or another suitable portion of the material sampling device that delivers material for a testing sample into the discharge chute 366. Similar to the embodiments discussed above, material analyzer assembly 270 and/or the support structure 278, may be removably or fixedly attached to any suitable portion of the material sampling device. It will be appreciated that in some embodiments, the discharge chute 266 may be omitted and the material analyzer assembly 270 and/or the support structure 278 may be fixedly or removably attached to another portion of the sampling device so that the first position is located at a discharge location suitable to obtain a testing sample.

In some embodiments, one or both of the sample containers 272a, 272b may be removably attached to the rotating member 275 such that one or both of the sample containers can be removed once the testing sample has been collected and analyzed. Upon removal of the sample container(s), the testing sample can be returned to the material supply, used for further testing or analysis, retained for future use, discarded, or otherwise handled as desired. In such an embodiment, the removable sample container(s) may or may not include a door or opening, such as doors 273a, 273b described below.

The first and second sample containers 272a, 272b are each configured to temporarily hold at least a portion of the crushed material discharged from the discharge chute 266 (i.e. the testing sample) while it is analyzed, before releasing the testing sample. Each sample container 272a, 272b includes a door 273a, 273b at the bottom of the respective sample container 272a, 272b configured to selectively retain the testing sample within the respective sample container 272a, 272b. The door 273a, 273b of the sample containers 272a, 272b may be a hinged door, a sliding door, a butterfly door similar to a carburetor, a rotating lid (shown in FIG. 10 and described below), or any other suitable structure configured to selectively retain the testing sample within the respective sample container 272a, 272b. The door/opening may also be positioned along the side of the respective container in some embodiments. In still other embodiments, one or both of the sample containers may include two or more doors configured to selectively retain the testing sample within the respective sample container. The door 273a, 273b may be configured to be opened and closed manually by an operator or the door 273a, 273b may be configured to automatically open and close after a certain time period, based on the presence or absence of sufficient material in the respective sample container 272a, 272b, or based on the presence or absence of some other appropriate condition. Suitable sensors and/or timers may be incorporated within the material analyzer assembly 270 to provide this type of functionality, but they are not required. When the respective door 273a, 273b is opened, the testing sample may be released back into the container or pile from which it was obtained, released to the ground, or delivered to a transport means (chute, conveyor belt, etc.) (not shown).

Material analyzer assembly 270 may be configured to rotate the first sample container 272a and the second sample container 272b between a first position and a second position. As shown, when the sample container 272a, 272b is in the first position, the sample container 272a, 272b is positioned underneath the discharge chute 266 to receive the testing sample and in a position to allow the testing sample to be analyzed by the first material analyzer 271a. When the sample container 272a, 272b is in the second position, the sample container 272a, 272b is in a position to allow the testing sample to be analyzed by the second material analyzer 271b. Specifically, in the first position, the sample container 272a, 272b is positioned between the first source 274a and the first detector 276a, and in the second position, the sample container 272a, 272b is positioned between the second source 274b and the second detector 276b. As shown, each source 274a, 274b and its respective detector 276a, 276b are oriented at an angle of about 90 degrees relative to the longitudinal axis of the sample container 272a, 272b positioned between them. It will be appreciated that in some embodiments, the source 274a, 274b and its respective detector 276a, 276b may be oriented an angle relative to the longitudinal axis of the sample container positioned between them of about 30 degrees, 45 degrees, or any other angle suitable to allow the analyzer 271a, 271b to obtain the desired information about the testing sample.

In an exemplary method of operation of material analyzer assembly 270 shown in FIG. 4, the material sampling device obtains material from the desired supply of material (e.g. a container (a truck bed, a train car, shipping container, barge, etc.), arranged in a free-standing mound or pile, located within the ground or a rock formation, etc.). The material is processed by the material sampling device and falls down through the discharge chute 266. The first sample container 272a is positioned in the first position underneath the discharge chute 266 with door 273a closed for a period of time sufficient to allow the desired testing sample to be collected within the first sample container 272a. While the first sample container 272a is receiving the desired testing sample, if the second sample container 272b contains a testing sample of material, then the testing sample of material in the second sample container 272b may be analyzed by the second material analyzer 271b. Once the desired testing sample has been collected within the first sample container 272a, then that testing sample may be analyzed by the first material analyzer 271a. Once the analysis on the testing sample contained in each sample container 272a, 272b has been completed, then the rotating member 275 rotates about 180 degrees. As a result of the rotation, the sample containers 272a, 272b switch positions. In other words, after the rotation, the second sample container 272b is positioned in the first position underneath the discharge chute 266 to receive a testing sample, and the first sample container 272a, which contains a testing sample, is positioned in the second position within the second material analyzer 271b for analysis.

In this exemplary method of operation, while the testing sample in the first sample container 272a is being analyzed by the second material analyzer 271b, the second sample container 272b may release the previously analyzed testing sample (if applicable) by opening and closing the door 273b and then a new testing sample of material may be delivered into the second sample container 272b from the discharge chute 266. Subsequently, after the analysis of the testing sample in the first sample container 272a is completed and the new testing sample has been collected within the second sample container 272b, then the testing sample in the second sample container 272b may be analyzed by the first material analyzer 271a. Once the analysis of the testing samples in both sample containers 272a, 272b has been completed, then the rotating member 275 again rotates about 180 degrees returning the first sample container 272a to the first position and the second sample container 272b to the second position. As described above, the previously analyzed testing sample in the first sample container 272a may be released by opening and closing door 273a and the process of filling and analyzing the testing sample in the sample container 272a, 272b in the first position and analyzing the testing sample in the other sample container 272a, 272b in the second position is repeated. It will be appreciated that the previously analyzed testing sample may be released from the respective sample container 272a, 272b while the sample container 272a, 272b is in either the first or second position or during the rotation between the first and second positions. It will be appreciated that this particular method may be beneficial if an operator desires to obtain two separate measurements of the same characteristic of the same testing sample for accuracy purposes or if the first material analyzer 271a and second material analyzer 271b are configured to determine different characteristics of the testing sample (e.g., first material analyzer 271a may be configured to determine the amount of moisture in the testing sample and second material analyzer 272b may be configured to determine the amount of rock or ash in the testing sample).

Material analyzer assembly 270 may be configured to continuously rotate the sample containers 272a, 272b at a rate suitable to allow for adequate filling and analysis. Alternatively, the material analyzer assembly 270 may be configured to intermittently rotate the sample containers 272a, 272b at predetermined intervals suitable to allow for adequate filling and analysis or based on the presence or absence of a certain condition (e.g., when a certain amount of material has been collected within a respective sample container 272a, 272b, when analysis has been completed, etc.). Suitable sensors and/or timers may be incorporated within the material analyzer assembly 270 to provide this type of functionality, but they are not required. Although the material analyzer assembly 270 shown in FIG. 3 depicts two sample containers and two material analyzers, it will be appreciated that other embodiments may incorporate any suitable number of sample containers and material analyzers.

In an alternate method of operation, material analyzer assembly 270 may be configured to continuously rotate the sample containers 272a, 272b such that the sample containers 272a, 272b intermittently pass underneath discharge chute 266 collecting material until such time as one or both of the sample containers 272a, 272b have collected a predetermined amount of material sufficient to constitute a desired testing sample. Once a desired testing sample has been collected in at least one of the sample containers 272a, 272b, then material analyzer assembly 270 may be configured to stop the sample containers 272a, 272b in the first and second positions so that the testing sample(s) in the at least one sample container 272a, 272b can be analyzed by the desired material analyzer 271a, 271b. Once analysis of the desired testing sample(s) has been completed, then rotating member 275 may rotate about 180 degrees so that the at least one sample container 272a, 272b can be analyzed by the other material analyzer 271a, 271b.

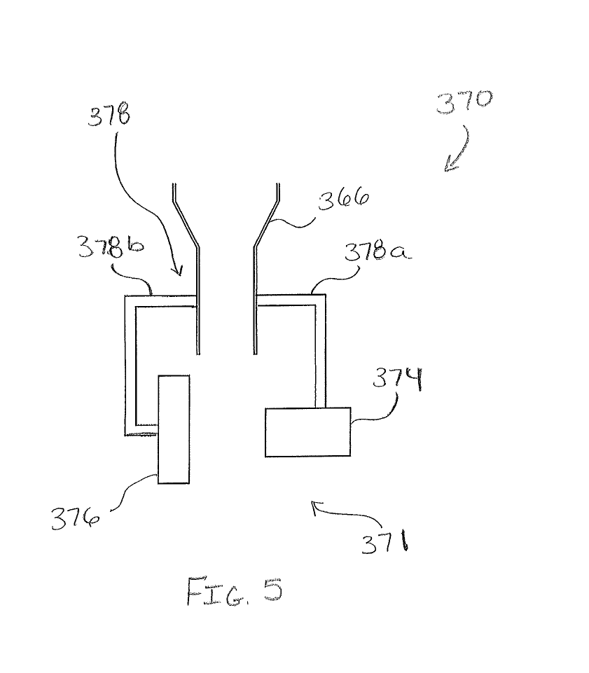

FIG. 5 depicts another alternate material analyzer assembly 370 configured to be fixedly or removably attached to a material sampling device. For example, material analyzer assembly 370 may be attached to a material sampling device such as material sampling device 20 described above and shown in FIGS. 1 and 2 or any other suitable material sampling device. As shown, material analyzer assembly 370 comprises a material analyzer 371 attached to the discharge chute 366 of the material sampling device via a support structure 378 that includes a first support arm 378a and a second support arm 378b. Similar to material analyzer 71 described above, material analyzer 371 may be configured to remain on continuously, or, alternatively, the material analyzer 371 may be configured to selectively switch between being on and off. In addition, the material analyzer 371 may be configured to provide an immediate audio or visual indication regarding the analyzed properties. The additional description regarding the functionality material analyzer 71 above applies equally to the material analyzer 371 in FIG. 5. As a result, that description will not be repeated here.

The material analyzer 371 in FIG. 5 includes an energy/particle source 374 and a detector 376. As shown, the source 374 and the detector 376 are each attached to the discharge chute 366 via a respective support arm 378a, 378b. If material analyzer assembly 370 is attached to a material sampling device that incorporates a crusher, such as material sampling device 20, then the discharge chute 366 may comprise a crusher discharge chute, such as the crusher discharge chute 66 described above. Alternatively, if material analyzer assembly 370 is attached to a material sampling device that does not incorporate a crusher, then the discharge chute 366 may be in direct communication with the separator assembly or another suitable portion of the material sampling device that delivers material for a testing sample into the discharge chute 366. Similar to the embodiments discussed above, material analyzer assembly 370 and/or the support structure 378 may be removably or fixedly attached to any suitable portion of the material sampling device. It will be appreciated that in some embodiments, the discharge chute 366 may be omitted and the material analyzer assembly 370 and/or the support structure 378 may be fixedly or removably attached to another portion of the sampling device so that the material analyzer 371 is located at a discharge location suitable to analyze a testing sample. Although FIG. 5 depicts a material analyzer assembly 370 that includes one material analyzer 371, it will be appreciated that other material analyzer assemblies may include two or more material analyzers attached to the discharge chute 366 or some other suitable portion of the material sampling device and configured to analyze material as it is discharged from the discharge chute 366.

As shown in FIG. 5, the source 374 and detector 376 of material analyzer 371 are positioned below the opening in discharge chute 366 so that at least a portion of the material discharged from discharge chute 366 passes between the source 374 and detector 376. As shown, the source 374 and the detector 376 are oriented at an angle of about 90 degrees relative to the longitudinal axis of path of the material as it falls from the discharge chute. It will be appreciated that in some embodiments, the source 374 and the detector 376 may be oriented an angle relative to the longitudinal axis of the path of the falling material of about 30 degrees, 45 degrees, or any other angle suitable to allow the analyzer 371 to obtain the desired information about the testing sample. Upon being discharged from discharge chute 366 and passing through material analyzer 371, the material may fall back into the container or pile from which it was obtained, onto the ground, or onto a transport means (chute, conveyor belt, etc.) (not shown). Material analyzer 371 is configured to be able to analyze the material as it is falling from the discharge chute. The material sampling device may be configured to allow an operator to control the speed of the flow of material being discharged from the discharge chute 366 in order to ensure that the material is flowing at a suitable rate to allow for analysis by the material analyzer 371. Instead of being positioned below the opening in discharge chute 366 as shown in FIG. 5, the source 374 and the detector 376 may be positioned on opposite sides of the body of discharge chute 366 so that the material analyzer 371 analyzes the material as it is traveling through the discharge chute 366 instead of after the material has been discharged from the discharge chute 366.

In an exemplary method operation of the material analyzer assembly 370 shown in FIG. 5, the material sampling device obtains material from the desired supply of material (e.g. a container (a truck bed, a train car, shipping container, barge, etc.), arranged in a free-standing mound or pile, located within the ground or a rock formation, etc.). The material is processed by the material sampling device and falls down through the discharge chute 366. Upon exiting the discharge chute 366, at least a portion of the core sample obtained by the material sampling device (i.e., the testing sample) passes through the material analyzer 371. In other words, upon exiting the discharge chute 366, the testing sample passes between the source 374 and the detector 376. The testing sample is then analyzed by the material analyzer 371 and the testing sample falls back into the container or pile from which it was obtained, onto the ground, or onto a transport means (chute, conveyor belt, etc.) (not shown). The analyzer 371 may be configured to continuously or periodically analyze the material flowing between the source 374 and the detector 376.

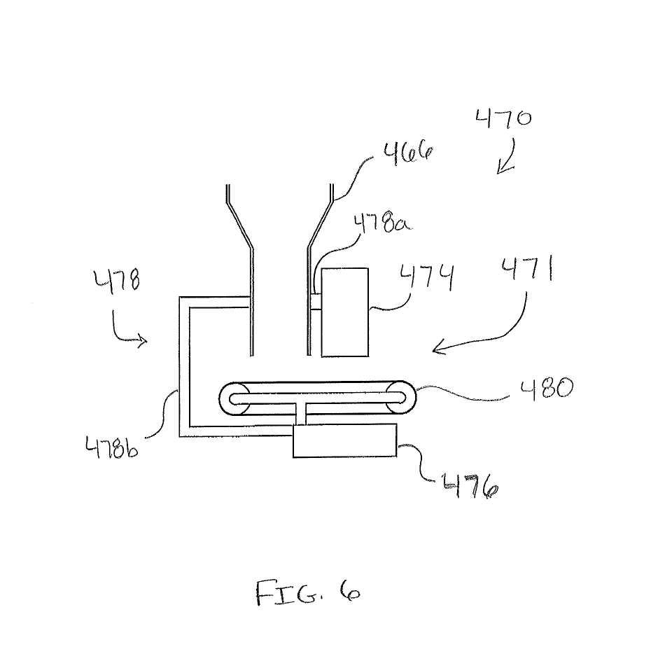

FIG. 6 depicts another alternate material analyzer assembly 470 configured to be fixedly or removably attached to a material sampling device. For example, material analyzer assembly 470 may be attached to a material sampling device such as material sampling device 20 described above and shown in FIGS. 1 and 2 or any other suitable material sampling device. As shown, material analyzer assembly 470 comprises a material analyzer 471 and a conveyor 480 that are attached to the discharge chute 466 via a support structure 478 that includes a first support arm 478a and a second support arm 478b. Similar to material analyzer 71 described above, material analyzer 471 may be configured to remain on continuously, or, alternatively, the material analyzer 471 may be configured to selectively switch between being on and off. In addition, the material analyzer 471 may be configured to provide an immediate audio or visual indication regarding the analyzed properties. The additional description regarding the functionality material analyzer 71 above applies equally to the material analyzer 471 in FIG. 6. As a result, that description will not be repeated here.

The material analyzer 471 in FIG. 6 includes an energy/particle source 474 and a detector 476. As shown, the source 474 is attached to the discharge chute 466 via the first support arm 478a and the detector 476 and conveyor are each attached to the discharge chute 466 via the second support arm 478b. In some embodiments, the first support arm 478a may be omitted and the source 474 may be attached directly to the discharge chute 466. If material analyzer assembly 470 is attached to a material sampling device that incorporates a crusher, such as material sampling device 20, then the discharge chute 466 may comprise a crusher discharge chute, such as the crusher discharge chute 66 described above. Alternatively, if material analyzer assembly 470 is attached to a material sampling device that does not incorporate a crusher, then the discharge chute 466 may be in direct communication with the separator assembly or another suitable portion of the material sampling device that delivers material for a testing sample into the discharge chute 466. Similar to the embodiments discussed above, material analyzer assembly 470 and/or support structure 478, may be removably or fixedly attached to any suitable portion of the material sampling device. It will be appreciated that in some embodiments, the discharge chute 466 may be omitted and the material analyzer assembly 470 and/or the support structure 478 may be fixedly or removably attached to another portion of the sampling device so that the conveyor 480 is located at a discharge location suitable to obtain a testing sample. Although FIG. 6 depicts a material analyzer assembly 370 that includes one material analyzer 471, it will be appreciated that other material analyzer assemblies may include two or more material analyzers attached to the discharge chute 466 or some other suitable portion of the material sampling device and configured to analyze testing samples as they travel along a conveyor.

As shown, the conveyor 480 is positioned below the opening of the discharge chute 466 so that at least a portion of the material discharged from the discharge chute 466 is discharged onto the conveyor 480. It will be appreciated that the conveyor 480 may comprise a conveyor belt, chute or other means for transporting the material through the material analyzer 471. The discharged material is then carried by conveyor 480 and delivered to a desired location. The conveyor 480 may be driven by a conventional motor or drive unit that is well known within the art. By way of example only, the conveyor 480 may deliver the material to separate container or onto the ground, or the conveyor 480 may allow the material to fall back into the container, pile, etc. that it was obtained from. It will be appreciated that the conveyor 480 may comprise any suitable length of configuration to deliver the material to the desired location. In the material analyzer illustrated in FIG. 6, the source 474 and detector 476 are positioned on opposite sides of the conveyor 480 so that the material passes between the source 474 and the detector 476 as it travels along the conveyor 480. As shown, the source 474 and the detector 476 are oriented at an angle of about 90 degrees relative to the longitudinal axis of the conveyor 480. It will be appreciated that in some embodiments, the source 474 and the detector 476 may be oriented an angle relative to the longitudinal axis of the conveyor 480 of about 30 degrees, 45 degrees, or any other angle suitable to allow the analyzer 471 to obtain the desired information about the testing sample. It will also be appreciated that the material analyzer 471 may be positioned at any point along the length of the conveyor 480 suitable to allow the material analyzer 471 to conduct the desired analysis.

In an exemplary method operation of the material analyzer assembly 470 shown in FIG. 6, the material sampling device obtains material from the desired supply of material (e.g. a container (a truck bed, a train car, shipping container, barge, etc.), arranged in a free-standing mound or pile, located within the ground or a rock formation, etc.). The material is processed by the material sampling device and falls down through the discharge chute 466. Upon exiting the discharge chute 466, at least a portion of the core sample obtained by the material sampling device (i.e., the testing sample) falls onto the conveyor 480. As the testing sample travels along the conveyor 480, it passes through the material analyzer 471. In other words, while traveling along the conveyor 480, the testing sample passes between the source 474 and the detector 476. The testing sample is then analyzed by the material analyzer 471 and the conveyor 480 delivers the testing sample to the desired location/container. The speed of the conveyor 480 may be controlled in order to make sure the testing sample remains between the source 474 and the detector 476 long enough for the analysis to be completed.

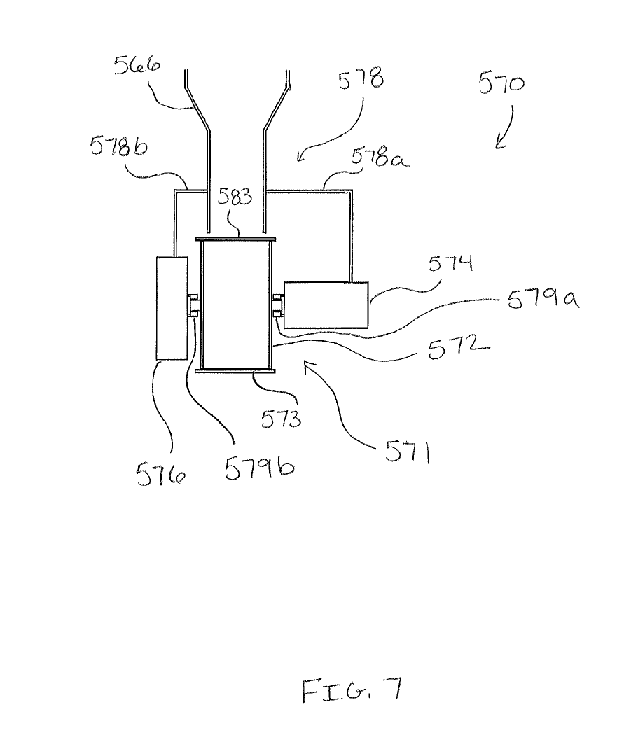

FIG. 7 depicts another alternate material analyzer assembly 570 configured to be fixedly or removably attached to a material sampling device. For example, material analyzer assembly 570 may be attached to a material sampling device such as material sampling device 20 described above and shown in FIGS. 1 and 2 or any other suitable material sampling device. As shown, material analyzer assembly 570 comprises a sample container 572 and a material analyzer 571. In the material analyzer assembly 570 shown in FIG. 7, the sample container 572 and the material analyzer 571 are attached to the discharge chute 566 via a support structure 578 that includes a first support arm 578a and a second support arm 578b. Similar to material analyzer 71 described above, material analyzer 571 may be configured to remain on continuously, or, alternatively, the material analyzer 571 may be configured to selectively switch between being on and off. In addition, the material analyzer 571 may be configured to provide an immediate audio or visual indication regarding the analyzed properties. The additional description regarding the functionality material analyzer 71 above applies equally to the material analyzer 571 in FIG. 7. As a result, that description will not be repeated here.

The material analyzer 571 in FIG. 7 includes an energy/particle source 574 and a detector 576. As shown, the source 574 is attached to the discharge chute 566 via the first support arm 578a and the detector 576 is attached to the discharge chute 566 via the second support arm 578b. If material analyzer assembly 570 is attached to a material sampling device that incorporates a crusher, such as material sampling device 20, then the discharge chute 566 may comprise a crusher discharge chute, such as the crusher discharge chute 66 described above. Alternatively, if material analyzer assembly 570 is attached to a material sampling device that does not incorporate a crusher, then the discharge chute 566 may be in direct communication with the separator assembly or another suitable portion of the material sampling device that delivers material for a testing sample into the discharge chute 566. Similar to the embodiments discussed above, material analyzer assembly 570 and/or support structure 578, may be removably or fixedly attached to any suitable portion of the material sampling device. It will be appreciated that in some embodiments, the discharge chute 566 may be omitted and the material analyzer assembly 570 and/or the support structure 578 may be fixedly or removably attached to another portion of the sampling device so that the sample container 572 is located at a discharge location suitable to obtain a testing sample. As shown in FIG. 7, the source 574 and the detector 576 are positioned on opposite sides of the sample container 572 and oriented at an angle of about 90 degrees relative to the longitudinal axis of the sample container 572.

It will be appreciated that in some embodiments, the source 574 and the detector 576 may be oriented an angle relative to the longitudinal axis of the sample container of about 30 degrees, 45 degrees, or any other angle suitable to allow the analyzer 571 to obtain the desired information about the testing sample.

As shown, the sample container 572 is positioned below the opening of the discharge chute 566 so that at least a portion of the material discharged from the discharge chute 566 is collected by the sample container 572. Sample container 572 in FIG. 7 is configured to rotate about a pair of pivots 579a, 579b in order to mix the testing sample collected within sample container 572. The rotation of sample container 572 may be powered by a conventional motor (not shown) that is mechanically connected to sample container 572 and/or pivots 579a, 579b. The sample container 572 may be connected to the source 574 and the detector 576 by pivots 579a, 579b, as shown in FIG. 7, or, alternatively, the pivots 579a, 579b may be attached to support structure 578 without being directly connected to the source 574 and the detector 576.

In some embodiments, the sample container 572 may be removably attached to the pivots 579a, 579b, the support structure 578, the source 574 and/or the detector 576 such that the sample container can be removed once the testing sample has been collected and analyzed. Upon removal of the sample container, the testing sample can be returned to the material supply, used for further testing or analysis, retained for future use, discarded, or otherwise handled as desired. In such an embodiment, the removable sample container may include one or two doors, such as top door 583 and/or bottom door 573 described below.

The sample container 572 shown in FIG. 7 is configured to temporarily hold at least a portion of the core sample obtained by the material sampling device that has been discharged from the discharge chute 566 (i.e. the testing sample) while it is analyzed, before releasing the testing sample. As shown, sample container 572 includes a bottom door 573 at the bottom of the sample container 572 and a top door 583 at the top of the sample container 572. Bottom door 573 and top door 583 may be configured to selectively open and close in order to allow the sample container 572 to receive the testing sample, retain the testing sample within the sample container 572 during rotation/mixing, and, subsequently release the testing sample after the rotation/mixing and analysis has been completed. Any suitable mechanism may be used to open and close doors 573, 583. Each door 573, 583 of sample container 572 may be a hinged door, a sliding door, a butterfly door similar to a carburetor, a rotating lid (shown in FIG. 10 and described below), or any other suitable structure configured to selectively open and close. The doors 573, 583 may be configured to be opened and closed manually by an operator or the doors 573, 583 may be configured to automatically open and close after a certain time period, based on the presence or absence of sufficient material in the respective sample container 572, or based on the presence or absence of some other appropriate condition. Suitable sensors and/or timers may be incorporated within the material analyzer assembly 570 to provide this type of functionality, but they are not required. Once the rotation/mixing and analysis have been completed and the bottom door 573 is opened, the testing sample may be released back into the container or pile from which it was obtained, released to the ground, or delivered to a transport means (chute, conveyor belt, etc.) (not shown).

In an exemplary method of operation, the bottom door 573 of the sample container 572 is closed and the top door 583 of the sample container 572 is open while the material sampling device obtains material from the desired supply of material (e.g. a container (a truck bed, a train car, shipping container, barge, etc.), arranged in a free-standing mound or pile, located within the ground or a rock formation, etc.). The material is processed by the material sampling device and falls down through the discharge chute 566 into the sample container 572. The bottom door 573 remains closed and the top door 583 remains open until an adequate amount of material is collected (i.e. the testing sample). Once a satisfactory testing sample is collected, then the top door 583 is closed and the sample container 573 is rotated about pivots 579a, 579b in order to sufficiently mix the testing sample. The testing sample is then analyzed by the material analyzer 571. Analysis can occur either: (i) while the sample container 572 is rotating or (ii) after mixing has been completed and sample container 572 has stopped rotating. Once the analysis has been completed, then the bottom door 573 is opened and the testing sample is released. When analysis of another testing sample is desired, the bottom door 73 may be closed, the top door 583 may be opened, and the process can be repeated.

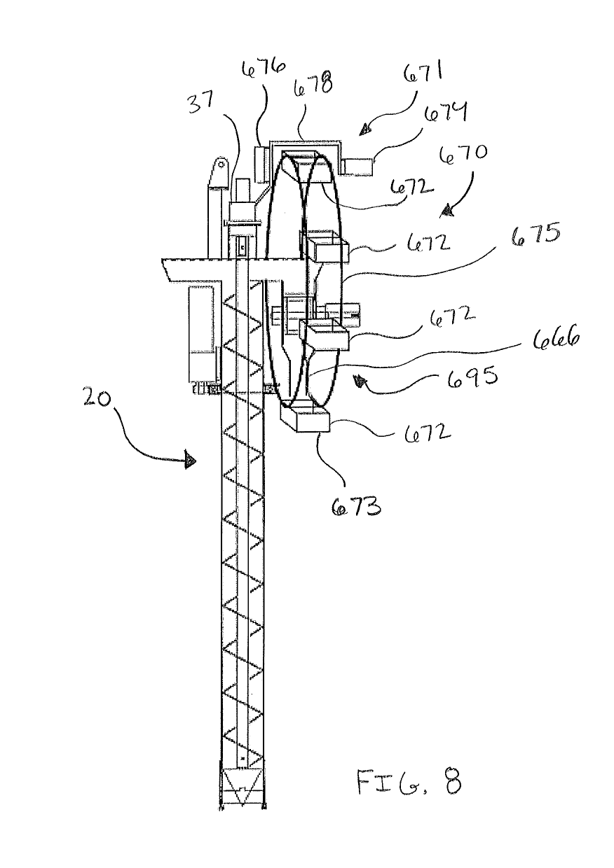

FIG. 8 depicts another alternate material analyzer assembly 670 configured to be fixedly or removably attached to a material sampling device. For example, as shown in FIG. 8, material analyzer assembly 670 may be attached to a material sampling device such as material sampling device 20 described above and shown in FIGS. 1 and 2 or any other suitable material sampling device. As shown, material analyzer assembly 670 comprises a rotating sample container assembly 695 and a material analyzer 671. The sample container assembly 695 comprises a rotating member 675 and a plurality of temporary sample containers 672 that are attached to and positioned circumferentially about the rotating member 695. Although FIG. 8 depicts a rotating sample container assembly 695 that includes four sample containers 672, it will be appreciated that any suitable number of sample containers may be included. Similarly, although FIG. 8 depicts a material analyzer assembly 670 that includes one material analyzer 671, it will be appreciated that any suitable number of material analyzers may be included.

In the material analyzer assembly 670 shown in FIG. 8, the rotating member 675 is attached to the sampling device 20 via at least one support member (not shown) and is powered by a motor (not shown). In the illustrated analyzer assembly 670, the material analyzer 671 is attached to the gearbox 37 of sampling device 20 via a support structure 678. Similar to material analyzer 71 described above, material analyzer 671 may be configured to remain on continuously, or, alternatively, the material analyzer 671 may be configured to selectively switch between being on and off. In addition, the material analyzer 671 may be configured to provide an immediate audio or visual indication regarding the analyzed properties. The additional description regarding the functionality material analyzer 71 above applies equally to the material analyzer 671 in FIG. 8. As a result, that description will not be repeated here.

The material analyzer 671 in FIG. 8 includes an energy/particle source 674 and a detector 676. Similar to the embodiments discussed above, material analyzer assembly 670 and/or support structure 678, may be removably or fixedly attached to any suitable portion of the material sampling device. As shown in FIG. 8, the source 674 and the detector 676 are positioned on opposite sides of the path of the rotating sample container assembly 695 so that each sample container 672 passes between the source 674 and the detector 676 as it rotates. As shown, the source 674 and the detector 674 are oriented at an angle of about 90 degrees relative to the longitudinal axis of each sample container 672 as it passes through the material analyzer 671. It will be appreciated that in some embodiments, the source 674 and the detector 676 may be oriented an angle relative to the longitudinal axis of the sample container of about 30 degrees, 45 degrees, or any other angle suitable to allow the analyzer 671 to obtain the desired information about the testing sample.

As shown, the rotating sample container assembly 695 is oriented vertically and the assembly 695 is positioned so that each sample container 672 passes below the opening of the discharge chute 666 so that at least a portion of the material discharged from the discharge chute 666 is collected by a sample container 672 as the sample container 672 passes below the discharge chute 666. If material analyzer assembly 670 is attached to a material sampling device that incorporates a crusher, such as material sampling device 20, then the discharge chute 666 may comprise a crusher discharge chute, such as the crusher discharge chute 66 described above. Alternatively, if material analyzer assembly 670 is attached to a material sampling device that does not incorporate a crusher, then the discharge chute 666 may be in direct communication with the separator assembly or another suitable portion of the material sampling device that delivers material for a testing sample into the discharge chute 666. It will be appreciated that in some embodiments, the discharge chute 666 may be omitted and the rotating sample container assembly 695 may be positioned so that each sample container 672 passes underneath a discharge location suitable to obtain a testing sample. The rotating sample container assembly 695 may be configured to continuously rotate at a speed that allows for both an adequate amount of material to be collected in each sample container 672 and for that sample to be analyzed by the material analyzer 671. Alternatively, the rotating sample container assembly 695 may rotate in discrete increments and intermittently pause a predetermined amount of time in order to allow for the desired sample to be obtained and/or analyzed. The rotation of rotating sample container assembly 695 may be powered by a conventional motor (not shown) that is mechanically connected to rotating member 675.

In some embodiments, each sample container 672 may be removably attached to the rotating member 675 such that the sample container can be removed once the testing sample has been collected and analyzed. Upon removal of the sample container, the testing sample can be returned to the material supply, used for further testing or analysis, retained for future use, discarded, or otherwise handled as desired. In such an embodiment, the removable sample container may include a door or opening, such as door 673 described below.

Each sample container 672 shown in FIG. 8 is configured to temporarily hold at least a portion of the core sample obtained by the material sampling device that has been discharged from the discharge chute 666 (i.e. the testing sample) while it is analyzed, before releasing the testing sample. Sample container 672 may include a bottom door 673 at the bottom of the sample container 672. Bottom door 673 may be configured to selectively open and close in order to allow the sample container 672 to retain the testing sample within the sample container 772 during rotation and analysis and, subsequently, release the testing sample after the analysis has been completed. Any suitable mechanism may be used to open and close bottom door 673. Bottom door 673 may be a hinged door, a sliding door, a butterfly door similar to a carburetor, a rotating lid (shown in FIG. 10 and described below), or any other suitable structure configured to selectively open and close. The bottom door 673 may be configured to be opened and closed manually by an operator or the bottom door 673 may be configured to automatically open and close at a certain point along the rotation path, after a certain time period, based on the presence or absence of sufficient material in the respective sample container 672, or based on the presence or absence of some other appropriate condition. Suitable sensors and/or timers may be incorporated within the material analyzer assembly 670 to provide this type of functionality, but they are not required. Once the rotation and analysis have been completed and the bottom door 673 is opened, the testing sample may be released back into the container or pile from which it was obtained, released to the ground, or delivered to a transport means (chute, conveyor belt, etc.) (not shown).

In an exemplary method of operation, the rotating sample container assembly 695 rotates in a vertical plane so that each sample container 672 passes underneath an opening in discharge chute 666 at the nadir of the rotation path and also passes through material analyzer 671 at the apex of the rotation path. It will be appreciated that the material analyzer 671 may be positioned at any suitable point along the rotation path. As each sample container passes underneath the discharge chute 666, the bottom door 673 of the sample container 672 is closed. The material sampling device 20 obtains material from the desired supply of material (e.g. a container (a truck bed, a train car, shipping container, barge, etc.), arranged in a free-standing mound or pile, located within the ground or a rock formation, etc.) and that material is processed by the material sampling device 20 and falls down through the discharge chute 666 into the sample container 672 positioned underneath the discharge chute 666. The bottom door 673 remains closed and the sample container 672 remains underneath the discharge chute 666 until an adequate amount of material is collected (i.e. the testing sample). Once a satisfactory testing sample is collected, then the rotating sample container assembly 695 either starts or continues rotating depending on the particular embodiment so that the sample container 672 containing the first testing sample travels up the rotation path to the material analyzer 671. As the sample container 672 containing the first testing sample is traveling toward the material analyzer 671, the next sample container 672 travels down the rotation path toward the opening in the discharge chute 666 and subsequently collects a second testing sample as that sample container passes underneath the discharge chute 666.

Once the sample container 672 containing the first sample reaches the material analyzer 671, then the first testing sample is analyzed by the material analyzer 671. Analysis can occur either: (i) while the sample container 672 is stationary between the source 674 and the detector 676 or (ii) as the sample container 672 travels between the source 674 and the detector 676. Once the analysis has been completed, the sample container 672 containing the first testing sample has passed through the material analyzer, and the sample container 672 containing the first testing sample begins traveling downward along the rotation path back toward the discharge chute 666, then the bottom door 673 may be opened at any point along the rotation path to release the first testing sample. In some embodiments, instead of or in addition to releasing the sample by opening the bottom door 673, the rotating sample container assembly 695 may be configured to release the testing sample from the respective sample container 672 by causing the sample container 672 to tip or flip over at some point along the rotation path after the analysis has been completed. The cycle then continues as the plurality of sample containers 672 travel along the rotation path and pass underneath the opening of the discharge chute 666 and through the material analyzer 671.

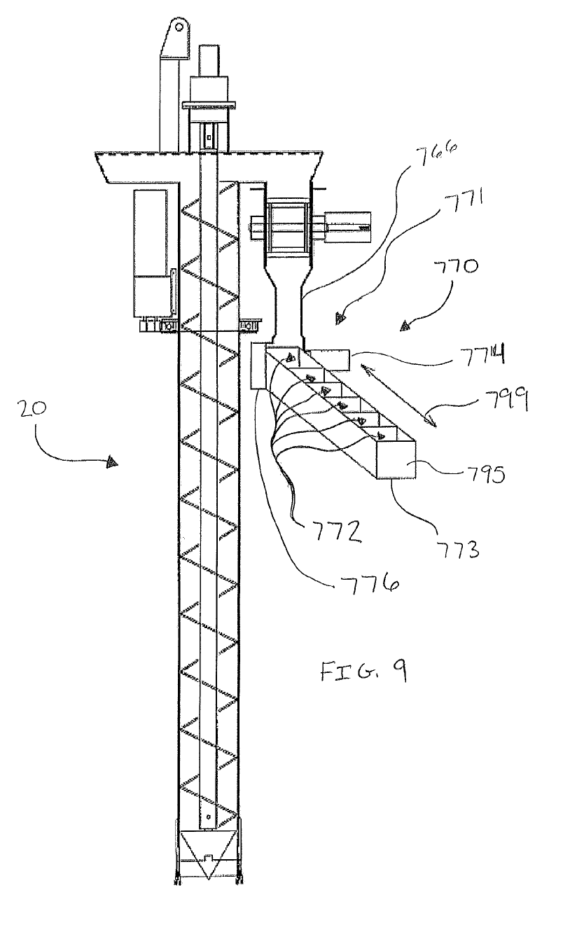

FIG. 9 depicts another alternate material analyzer assembly 770 configured to be fixedly or removably attached to a material sampling device. For example, as shown in FIG. 9, material analyzer assembly 770 may be attached to a material sampling device such as material sampling device 20 described above and shown in FIGS. 1 and 2 or any other suitable material sampling device. As shown, material analyzer assembly 770 comprises a translatable sample tray 795 and a material analyzer 771. The sample tray 795 is divided up into several individual compartments or temporary sample containers 772. Although FIG. 9 depicts a sample tray 795 that includes six sample containers 772, it will be appreciated that any suitable number of sample containers may be included in sample tray 795. Similarly, although FIG. 9 depicts a material analyzer assembly 770 that includes one material analyzer 771, it will be appreciated that any suitable number of material analyzers may be included.

In the material analyzer assembly 770 shown in FIG. 9, the sample tray 795 may be attached to the discharge chute 766 and/or the material analyzer 771 via a guide assembly or track. The guide assembly may be configured to allow the sample tray 795 to travel back and forth underneath the opening of the discharge chute 766 and between the source 774 and detector 776 of material analyzer 771. The movement of the sample tray 795 may be powered by a solenoid, a motor, or any other suitable linear actuator configured to cause the sample tray 795 to travel back and forth. In the illustrated analyzer assembly 770, the material analyzer 771 is attached to the discharge chute 766 of sampling device 20. Similar to material analyzer 71 described above, material analyzer 771 may be configured to remain on continuously, or, alternatively, the material analyzer 771 may be configured to selectively switch between being on and off. In addition, the material analyzer 771 may be configured to provide an immediate audio or visual indication regarding the analyzed properties. The additional description regarding the functionality material analyzer 71 above applies equally to the material analyzer 771 in FIG. 9. As a result, that description will not be repeated here.

The material analyzer 771 in FIG. 8 includes an energy/particle source 774 and a detector 776. Similar to the embodiments discussed above, material analyzer assembly 770 may be removably or fixedly attached to any suitable portion of the material sampling device. As shown in FIG. 9, the source 774 and the detector 776 are positioned on opposite sides of the path of the sample tray 795 so that the sample tray 795, and, consequently, each sample container 772 contained therein, passes between the source 774 and the detector 776 as the sample tray 795 travels back and forth. As shown, the source 774 and the detector 774 are oriented at an angle of about 90 degrees relative to the longitudinal axis of the sample tray 795 as it passes through the material analyzer 771. It will be appreciated that in some embodiments, the source 774 and the detector 776 may be oriented an angle relative to the longitudinal axis of the sample tray of about 30 degrees, 45 degrees, or any other angle suitable to allow the analyzer 671 to obtain the desired information about the testing sample.

As shown, the sample tray 795 is oriented substantially horizontally and the sample tray 795 is positioned so that each sample container 772 passes below the opening of the discharge chute 766 so that at least a portion of the material discharged from the discharge chute 666 is collected by a sample container 772 as the sample container 772 passes below the discharge chute 666. If material analyzer assembly 770 is attached to a material sampling device that incorporates a crusher, such as material sampling device 20, then the discharge chute 766 may comprise a crusher discharge chute, such as the crusher discharge chute 66 described above. Alternatively, if material analyzer assembly 770 is attached to a material sampling device that does not incorporate a crusher, then the discharge chute 766 may be in direct communication with the separator assembly or another suitable portion of the material sampling device that delivers material for a testing sample into the discharge chute 766. It will be appreciated that in some embodiments, the discharge chute 766 may be omitted and the sample tray 695 may be positioned so that each sample container 772 passes underneath a discharge location suitable to obtain a testing sample. The sample tray 795 may be configured to continuously travel back and forth at a speed that allows for both an adequate amount of material to be collected in each sample container 772 and for that sample to be analyzed by the material analyzer 771. Alternatively, the sample tray 795 may travel in discrete increments and intermittently pause a predetermined amount of time in order to allow for the desired sample to be obtained and/or analyzed.

In some embodiments, each sample container 772 may comprise a removable retainer held within an individual compartment of sample tray 795 such that the sample container can be removed once the testing sample has been collected and analyzed. Upon removal of the sample container, the testing sample can be returned to the material supply, used for further testing or analysis, retained for future use, discarded, or otherwise handled as desired. In such an embodiment, the removable sample container may include a door or opening, such as door 773 described below.

Each sample container 772 shown in FIG. 9 is configured to temporarily hold at least a portion of the core sample obtained by the material sampling device that has been discharged from the discharge chute 766 (i.e. the testing sample) while it is analyzed, before releasing the testing sample. Each sample container 772 and/or the sample tray 795 may include a bottom door 773 at the bottom of the respective sample container 772/sample tray 795. Bottom door 773 may be configured to selectively open and close in order to allow the sample container 772 to retain the testing sample within the sample container 772 during analysis and, subsequently, release the testing sample after the analysis has been completed. Any suitable mechanism may be used to open and close bottom door 773. Bottom door 773 may be a hinged door, a sliding door, a butterfly door similar to a carburetor, a rotating lid (shown in FIG. 10 and described below), or any other suitable structure configured to selectively open and close. The bottom door 773 may be configured to be opened and closed manually by an operator or the bottom door 773 may be configured to automatically open and close at a certain point along the travel path of the sample tray 795, after a certain time period, based on the presence or absence of sufficient material in the respective sample container 772 or sample tray 795, or based on the presence or absence of some other appropriate condition. Suitable sensors and/or timers may be incorporated within the material analyzer assembly 770 to provide this type of functionality, but they are not required. Once the analysis has been completed and the bottom door 773 is opened, the testing sample may be released back into the container or pile from which it was obtained, released to the ground, or delivered to a transport means (chute, conveyor belt, etc.) (not shown).

In an exemplary method of operation, the sample tray 795 travels back and forth in a substantially horizontal plane (as indicated by arrow 799) so that each sample container 772 passes underneath an opening in discharge chute 766 and also passes through material analyzer 771. It will be appreciated that the material analyzer 771 may be positioned at any suitable point along the travel path of sample tray 795. As each sample container passes underneath the discharge chute 666, the bottom door 773 of the sample container 772 is closed. The material sampling device 20 obtains material from the desired supply of material (e.g. a container (a truck bed, a train car, shipping container, barge, etc.), arranged in a free-standing mound or pile, located within the ground or a rock formation, etc.) and that material is processed by the material sampling device 20 and falls down through the discharge chute 766 into the sample container 772 positioned underneath the discharge chute 766. The bottom door 773 remains closed and the sample container 772 remains underneath the discharge chute 766 until an adequate amount of material is collected (i.e. the testing sample). Once a satisfactory testing sample is collected, then the testing sample is analyzed by the material analyzer 771.

Once the testing sample in the first sample container 772 has been collected and analyzed, then the sample tray 795 travels along its path so that the next sample container 772 in the sample tray 795 passes under the opening in the discharge chute 766 and through the material analyzer 771 so a second testing sample can be collected and analyzed. After the first testing sample has been analyzed, the bottom door 773 on the first sample container 772 may be opened to release the first testing sample. The first testing sample can be released or removed from the sample tray 795 at any point after the analysis has been completed. The process is repeated for each sample container 772 as the sample tray 795 travels back and forth along the travel path so that each sample container 772 in the sample tray 795 passes underneath the opening in the discharge chute 766 and through the material analyzer 771.

FIG. 10 depicts one example of a sample container lid that could be used as bottom doors 73, 173a, 173b, 273a, 273b, 573, 673, 773 or top door 583 in addition to the other types of doors mentioned above. Specifically, FIG. 10 shows a sample container 872 and a rotating lid 873. As shown, rotating lid 873 includes a rotating member 874 that engages the rotating lid 873 at a point spaced apart from the center of the rotating lid 873. Specifically, in the illustrated embodiment, the rotating member 874 engages the rotating lid 874 at a point adjacent to the outer edge of the rotating lid 873. In other words, the longitudinal axis of the rotating member 874 is parallel to but spaced apart from the central axis of the rotating lid 873 and the sample container 872. The rotating member 874 may be engaged with a motor or other suitable actuator configured to cause the rotating member 874 and the rotating lid 873 to rotate in unison with each other.

As a result of the off-center engagement between the rotating member 874 and the rotating lid 873, rotation of the rotating member 874 causes the rotating lid 873 to rotate between a first, closed position and a second, open position (shown in dashed lines in FIG. 10). As shown, when the rotating lid 873 is in the closed position. By way of example, if rotating lid 873 is being used as a bottom door, then the rotating lid 873 may be transitioned to the closed position to close the adjacent opening 875 of the sample container 872 and allow the testing sample to be collected by the sample container 872. In addition, if rotating lid 873 is being used as a bottom door, then the rotating lid 873 may be transitioned to the open position to open the adjacent opening 875 of the sample container 872 and release the testing sample from the sample container 872. In another example, if rotating lid 873 is being used as a top door, then the rotating lid 873 may be transitioned to the closed position to prevent material from being collected within the sample container 872 and transitioned to the open position to allow a testing sample to be collected within the sample container 872. It should be noted that in FIG. 10 rotating lid 873 is shown as being vertically spaced apart from the lower edge of the sample container 872 for clarity, but, in practice rotating lid 873 may be positioned so that rotating lid 873 abuts the lower edge of the sample container 872 when it is in the closed position in order to provide an adequate seal or closure.

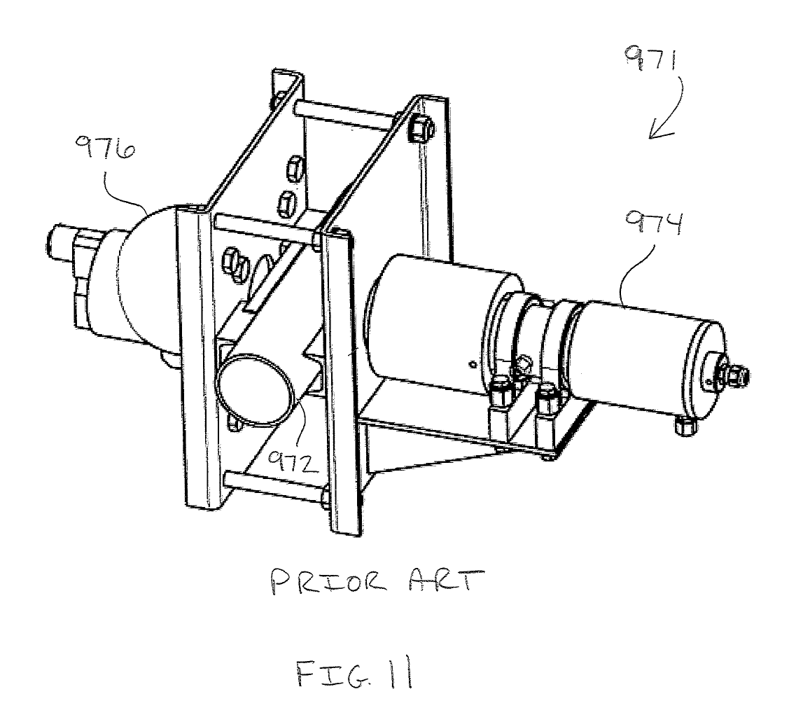

The material analyzers 71, 171, 271a, 271b, 371, 471, 571, 671, 771 described herein may comprise any suitable type of analyzer, including but not limited to a particle-based analyzer (such as a nuclear source analyzer) or an energy-based analyzer (such as an x-ray analyzer or a microwave analyzer). For example, in material analyzers that comprise a source and a detector, the respective source 74, 174, 274a, 274b, 374, 474, 574, 674, 774 and detector 76, 176, 276a, 276b, 376, 476, 576, 676, 776 may comprise a source and a detector such as those utilized in the LB 379 Measuring System or LB 444 Measuring Systems sold by Berthold Technologies GmbH & Co. KG. FIG. 11 depicts an example of a prior art material analyzer 971 sold by Berthold Technologies GmbH & Co. KG that includes an energy/particle source 974 and a detector 676 positioned on either side of a pipe 972 through which the material to be analyzed flows. It will also be appreciated that the material analyzers 71, 171, 271a, 271b, 371, 471, 571, 671, 771 described herein may be in communication, either via wireless or wired communication, with an evaluation unit, display or other storage device so that the results of the analysis performed by the material analyzers 71, 171, 271a, 271b, 371, 471, 571, 671, 771 may be reported back to the connected evaluation unit, display or other storage device.

In some alternate embodiments, the material sampling device may include a means for limiting the amount of material flowing into the material analyzer assembly. For example, the material sampling device may include a secondary sampler positioned between the crusher and the material analyzer assembly. The secondary sampler may be beneficial if there is a large amount of material being delivered into the primary sampler by the auger.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1) A material sampling and analyzing assembly comprising:
a material sampling device, wherein the material sampling device is configured to extract a core sample of material from a supply of material; and
a material analyzer assembly, wherein the material analyzer assembly is attached to a portion of the material sampling device, wherein the material analyzer assembly comprises a first material analyzer configured to analyze a first testing sample, wherein the first testing sample comprises a first portion of the core sample.

2) The material sampling and analyzing assembly of claim 1, wherein the first material analyzer comprises a first source and a first detector.

3) The material sampling and analyzing assembly of claim 1, wherein the material sampling device comprises a discharge chute, and wherein the material analyzer assembly is attached to the discharge chute.

4) The material sampling and analyzing assembly of claim 3, wherein the first material analyzer is positioned to analyze the first testing sample after the first testing sample has exited the discharge chute.

5) The material sampling and analyzing assembly of claim 1, wherein the material analyzer assembly further comprises a first sample container configured to retain the first testing sample.

6) The material sampling and analyzing assembly of claim 5, wherein the first material analyzer comprises a first source and a first detector, wherein the first sample container is rotatably mounted on a pair of pivots.

7) The material sampling and analyzing assembly of claim 5, wherein the material analyzer assembly further comprises a second sample container configured to temporarily retain a second testing sample, wherein the second testing sample comprises a second portion of the core sample.

8) The material sampling and analyzing assembly of claim 7, wherein the material analyzer assembly further comprises a rotating member and a motor, wherein the first sample container and the second sample container are attached to the rotating member and the rotating member is in mechanical communication with the motor.

9) The material sampling and analyzing assembly of claim 8, wherein the material analyzer assembly further comprises a second material analyzer.

10) The material sampling and analyzing assembly of claim 9, wherein the rotating member and the motor are configured to rotate the first sample container and the second sample container between a first position where the respective sample in the respective sample container can be analyzed by the first material analyzer and a second position where the respective sample in the respective sample container can be analyzed by the second material analyzer.

11) The material sampling and analyzing assembly of claim 1 further comprising a hose and funnel assembly, wherein the hose and funnel assembly is configured to receive the first sample after it has been analyzed by the first material analyzer.

12) The material sampling and analyzing assembly of claim 1, wherein the material analyzer assembly further comprises a conveyor configured to receive the first sample after the first sample has been discharged from the material sampling device, wherein the material analyzer is positioned to analyze the first sample as the first sample travels on the conveyor.

13) A material sampling and analyzing assembly comprising:
a material sampling device, wherein the material sampling device comprises a discharge location, wherein the material sampling device is configured to extract a core sample of material from a supply of material and discharge at least a portion of the core sample at the discharge location; and
a material analyzer assembly, wherein the material analyzer assembly is positioned at the discharge location, wherein the material analyzer assembly comprises a material analyzer configured to analyze a testing sample, wherein the testing sample comprises at least a portion of the core sample.

14) The material sampling and analyzing assembly of claim 13, wherein the material analyzer assembly further comprises a sample container, wherein the sample container is configured to receive and temporarily retain the first testing sample.

15) The material sampling and analyzing assembly of claim 13, wherein the material analyzer assembly further comprises a support structure that is attached to the material analyzer, wherein at least a portion of the support structure is attached to the material sampling device.

16) A material sampling and analyzing assembly comprising:
a material sampling device, wherein the material sampling device comprises a discharge chute, wherein the material sampling device is configured to extract a core sample of material from a supply of material; and
a material analyzer assembly, wherein the material analyzer assembly comprises
a sample container, wherein the sample container is attached to the discharge chute and is configured to receive and temporarily retain a testing sample that is discharged from the discharge chute, wherein the testing sample comprises at least a portion of the core sample, and
a material analyzer, wherein the material analyzer is configured to analyze the testing sample while it is retained by the sample container.

17) The material sampling and analyzing assembly of claim 16, wherein the sample container comprises a door configured to selectively open and close.

18) The material sampling and analyzing assembly of claim 17, wherein the door is selected from the group consisting of a hinged door, a sliding door, a butterfly door, and a rotating lid.

19) The material sampling and analyzing assembly of claim 16, wherein the material analyzer comprises a source and a detector.

20) The material sampling and analyzing assembly of claim 19, wherein the source and the detector are positioned on opposite sides of the sample container.
